(19) United States
(12) Patent Application Publication
(10) Pub. No.: US 2012/0180373 A1
(43) Pub. Date: Jul. 19, 2012

(54) FISHING ROD ASSEMBLY

(76) Inventor: Wolfgang Triller, Mengkofen (DE)

(21) Appl. No.: 13/390,616

(22) PCT Filed: Jul. 23, 2010
(86) PCT No.: PCT/DE2010/000862

§ 371 Date: Apr. 5, 2012

(30) Foreign Application Priority Data
Aug. 17, 2009 (DE) 10 2009 037 508.2
Feb. 23, 2010 (DE) 10 2010 009 139.1

(51) Int. Cl. A01K 87/06

(52) U.S. Cl. 43/22

(57) ABSTRACT

A fishing rod assembly comprising a fishing rod (2, 12) and a fishing reel (3, 13) having a foot (4, 14) which serves to fasten the fishing reel to the fishing rod, characterized in that both the foot (4, 14) of the fishing reel (3, 13) and the fishing rod (2, 12) have respective recesses (18, 23) for jointly receiving at least one detachable fastening means (6, 25) for locating the fishing reel in position on the fishing rod.

The present invention relates to a fishing rod assembly comprising a fishing rod and a fishing reel having a foot which serves to fasten the fishing reel to the fishing rod.

Fishing rod assemblies of this kind are known from prior art. The fasteners for securing the reel to the rod are known to mostly consist of screw-threaded mechanisms, rigid connections or tubed connections with prescribed angle brackets designed very heavy especially on larger reels. Even a fast spool change is still only possible relatively slowly and complicated with the known kinds of securing the reel to the rod. On rods known from prior art attaching the foot to the rod defines the position of reel to rod unchangeable. This results in a nuisance in handling and, furthermore, in disadvantages in paying out the line from the spool and in guiding the line through the nearest guide ring of the rod.

The present invention is based on the object of providing a fishing rod assembly which does away with the disadvantages of prior art fishing rod assemblies, it particularly being based on the object of providing a lightweight fishing rod assembly which now makes it possible to change the reel and/or the spool speedily whilst also facilitating altering the angle of the reel to the rod.

This object is achieved by a fishing rod assembly of the aforementioned kind characterized in that both the foot of the fishing reel and the fishing rod have respective recesses for jointly receiving at least one detachable fastening means for locating the fishing reel in position on the fishing rod. Arranging recesses in the rod and foot of the reel to receive in common a releasable fastening means now makes it possible to secure and release the reel to/from the rod speedily with no complication. In addition to this, fastening the reel to the rod in accordance with the invention makes for a substantial reduction in weight.

As a rule the foot is rigidly connected to the reel. The reel or its housing along with the foot as part thereof may be engineered in one piece.

Preferably the at least one fastening means is a pin, preferably a spring pin, pressure pin or gib. Fastening means of this kind now makes it possible to provide a particularly simple design whilst permitting speedy, facilitated changing of the reel. The cited fastening means engage in one or more recesses in the foot (e.g. channels, grooves, holes, etc) to locate the foot relative to the rod. Preferably the foot of the reel includes a fastening plate arranged in the longitudinal direction of the rod with at least one recess. Such a fastening plate is engineered for ideally locating a recess in the rod (see below).

In one preferred embodiment of the fishing rod assembly in accordance with the invention the angular position of the logitudinal direction (centerline) of the reel and reel thereof is variable relative to the longitudinal centerline of the rod, said two longitudinal centerlines being oriented in the same plane, the at least one fastening means serving to locate the wanted angular position. This makes it possible for the angler to adapt the location the reel relative to the rod both speedily and easily.

Preferably the foot of the reel is hinged to pivot about a shaft arranged at the reel and oriented at right angles to the longitudinal direction of the foot (or rod) to allow the reel to pivot to and from the rod. Pivoting the reel in this way enables the spool to be positioned nearer to or further from the rod, in thus rendering the angular position adjustable so that the longitudinal centerline of the spool of the reel in its extension points to the centerpoint of the nearest guide ring of the rod. The advantage of this is that the line running off from the spool in throwing, i.e. in the throwing phase now has the smallest achievable change in angle at the guide ring needed to guide the line further along the rod. In addition to this the line is payed out to advantage from the spool symmetrically to the direction of its longitudinal centerline in thus avoiding irregularities in paying out the line. This in turn minimizes the friction of the line running through the guide ring, optimizing the reach in throwing the bait.

These preferred embodiments as described achieving variable angular positioning now make it possible to vary the spacing of the reel from the rod to be fixedly located in each position. This results in a number of advantages. For one thing, the angler can now select the spacing of the reel from the rod for an optimum confortable hand fit to grip by his index finger either the edge of the spool or the line itself. In addition, this now enables changing the spacing and position of the reel from the first guide ring of the rod in helping to optimize the angle of the line in being payed out to the longitudinal centerline of the reel and to the longitudinal centerline of the rod.

To advantage the foot of the reel, preferably the fastening plate of the foot, comprises multiple recesses preferably arranged one above the other. The recesses may also intermerge or be interconnected. Providing multiple such recesses now facilitates attaining variable angles as explained above. Changing the angle in this way may also be attainable speedily facilitated via tooth and/or shaft drillings or tapered locking pins in the foot of the reel.

To advantage the rod comprises further, preferably full-length recesses for channeling parts of the foot, particularly of the fastening plate of the foot arranged preferably offset by 90° from the recess for receiving the releasable fastening means. It is in this way that, for example, the fastening plate of the foot is located within the rod. To advantage in the cited recess the shaft, as aforementioned, is arranged at right angles to the longitudinal direction of the foot or rod and serves, for example, a hook-shaped portion of the foot of the reel as a positive counter part to permit achieving pivoting the foot and thus the reel (see also description of the FIGS).

Preferably the rod is configured in the region of the aforementioned recess reinforced especially thicker in enhancing the stability of the rod in the region of the recesses.

Further features of the invention read from the following description of preferred embodiments of the invention in conjunction with the drawings and sub-claims, it being understood that each of the features may be achieved by itself or in any combination with each other.

### IN THE DRAWINGS

FIG. 1 is a view of a fishing rod assembly in accordance with the invention;

FIG. 2a,b are diagrammatic views of the fishing rod assembly as shown in FIG. 1 with the reel diversely pivoted;q

FIG. 3: is a view of a further embodiment of a fishing rod assembly in accordance with the invention

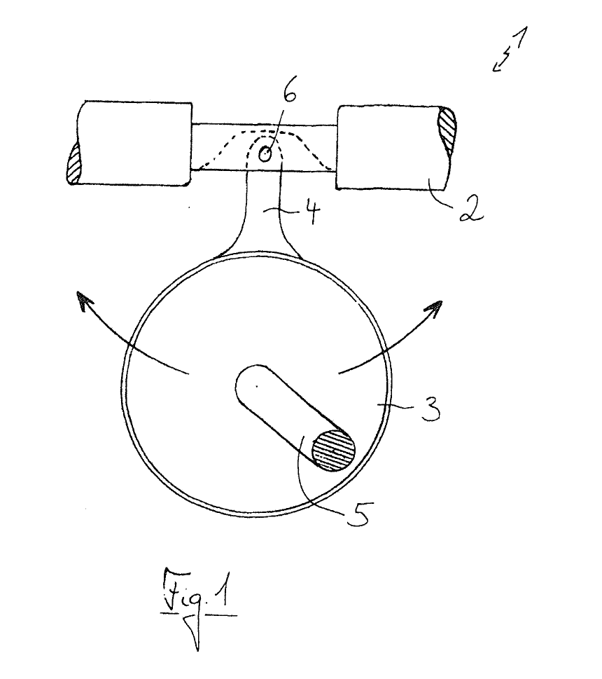

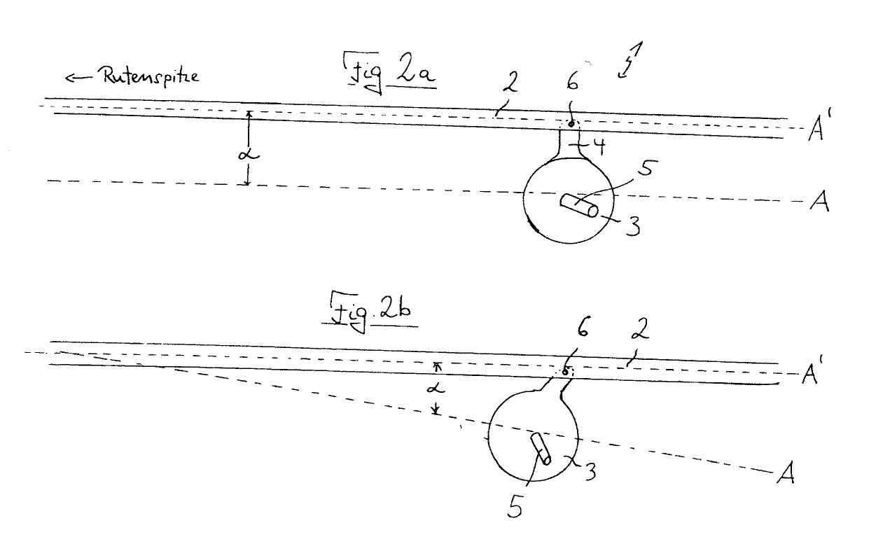

Referring now to FIG. 1 there is illustrated a fishing rod assembly 1 in accordance with the invention including a rod 2 and a reel 3. The fishing rod assembly 1 is designed suitable for fly-fishing. The reel 3 comprises furthermore a foot 4 for securing the reel 3 to the rod 2. The reel 3 comprises furthermore a handle 5 for actuating the reel 3. Both the foot 4 of the reel 3 as well as the rod 2 each comprise a recess for receiving together a releasable fastening means (in this case a pin fastener 6) for fastening the reel 3 to the rod 2. Simply and expediently by releasing the pin fastener 6 which may be, for example, a spring or pressure pin, the reel 3 can be released from the rod 2 or fitted thereto. After loosening or removing the pin fastener 6 the reel 3 can be pivoted forwards in the direction of the tip of the rod or backwards in the direction of the butt of the rod in which position it can be fixed (as shown in FIGS. 2a and 2b in particular). The pin fastener may also be a screw.

Referring now to FIGS. 2a and 2b there is illustrated the fishing rod assembly 1 in diverse diagrammatic views. On the fishing rod assembly 1 the angular position a of the longitudinal centerline A of the reel 3 and its spool can be varied relative to the longitudinal centerline A′ of the rod 2, both longitudinal centerlines A,A′ being oriented in the same plane. The pin fastener 6 serves to locate the wanted angular location. FIG. 2a shows a position of the reel 3 in which the longitudinal centerline A of the reel 3 is oriented parallel to the longitudinal centerline A′ of the fishing rod.

Referring now to FIG. 2b there is illustrated the fishing rod assembly 1 after the reel 3 has been pivoted forwards in the direction of the tip of the rod and fixed in this position. In this case the two longitudinal centerlines A and A′ form an acute angle.

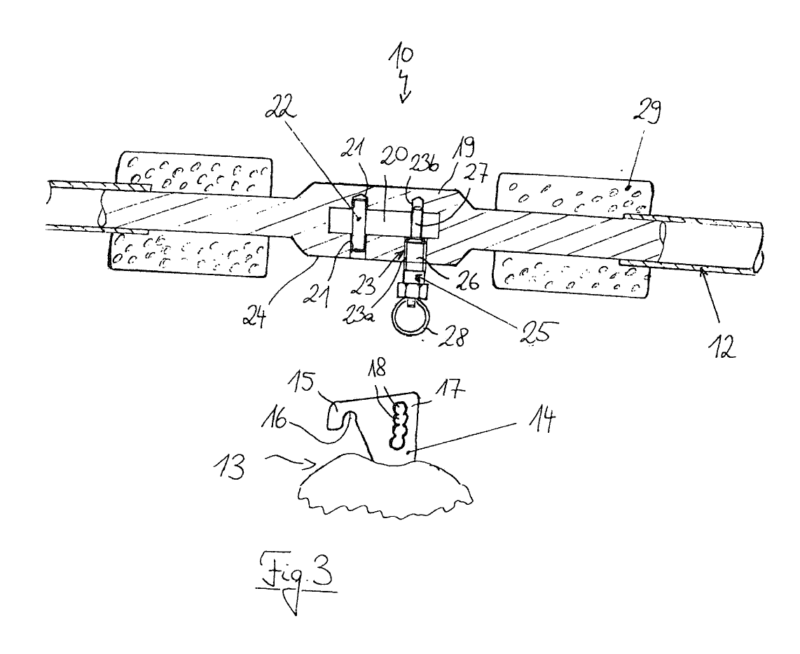

Referring now to FIG. 3 there is illustrated a further development of a fishing rod assembly 10 in accordance with the invention including a rod 12 and a reel 13, the reel 13 being shown for a better overview in a position dismantled from the rod. The reel 13 comprises a foot 14 serving to secure the reel 3 to the rod 12. The foot 14 is configured as a flat plate ending in a hook-shaped element 15. The hook-shaped element 15 is bottomed by a semi-circular shaped portion 16. The hook-shaped element 15 protrudes from the main part of the foot 14 namely the fastening portion 17. Arranged in the fastening portion 17 are four recesses 18 located one above the other which are not totally separated from each other, they instead merging into each other in the fastening portion 17.

In the region of the rod 2 where the foot 4 is arranged, the rod 2 is configured thicker. It is in this thickened portion 19 of the rod 2 that a rectangular recess 20 is machined in the longitudinal direction of the rod 2. This recess serves to receive the foot 4. Also machined in the thickened portion 19 of the rod 2 is a likewise rectangular recess 21 arranged at right angles to the recess 20. This recess 21 protrudes by both ends beyond the recesses 20, thus resulting in two recesses facing each other to be exact. In the interior of the recess 21 a shaft 22 is provided which is located in the recess 21.

Machined in the thickened portion 19 of the rod 2 parallel to the recess 21 is a further recess 23 extending from one edge 24 of the thickened portion 19 firstly up to the recess 20 of the thickened portion 19 in thereby forming a full-length channel from the surface of the thickened portion 19 of the rod 2 to the recess 20 in the interior of the thickened portion 19. The recess 23 finds its continuation at the opposite side of the recess 20, it being configured narrower at this place 23a in also not continuing to the surface of the thickened portion 19 (blind hole). This narrower portion 23a of the recess 23 is arranged in line with the wider portion 23b of the recess 23, in other words the longitudinal centerlines of the portions 23a and 23b of the recess 23 coincide. Provided in the recess 23 is a spring pin 25 featuring a wider head portion 26 and a narrower neck portion 27. The wider head portion 26 of the spring pin 25 is adapted in size and shape of the wider portion 23b of the recess 23. The narrower neck portion 27 of the spring pin 25 is adapted to the narrower portion 23a of the recess 23. The spring pin 25 comprises a fastening ring 28 with which the spring pin 25 can be withdrawn from the the recess 23 to the extent that the narrower neck portion 27 of the spring pin 25 completely exposes the recess 20.

To fasten the foot 4 the spring pin 25 is first withdrawn sufficiently from the recess 20 so that the foot with its fastening portion 17 can be guided through the recess 20. Before this, the hook-shaped element 15 of the foot 14 is positioned so that the semi-circular shaped portion 16 clasps the pin 22. Depending on the wanted position of the reel 13 the narrower neck portion 27 of the fastening ring 28 is inserted through one of the four recess 18 arranged one above the other in the foot 14, resulting in the foot 14 being located in position.

To change the angle between the longitudinal centerline of the reel to the longitudinal centerline of the rod all that is needed is to withdraw the spring pin 25 from the recess 20. The pin 22 then serves as the shaft for pivoting the foot 4, after which the reel 3 is positioned as desired. As soon as this position is attained the spring pin 25 is released to snap into place in one of the wanted recesses 18 in the foot 14.

To make for a better grip the rod 12 can be partly sheathed in cork 29.

1. A fishing rod assembly comprising:
a fishing rod having a first recess; and
a fishing reel having a foot which serves to fasten the fishing reel to the fishing rod, said foot having a second recess, said first recess and said second recess jointly receiving at least one detachable fastener locating the fishing reel in position on the fishing rod.

2. The fishing rod assembly as set forth in claim 1, in which the at least one detachable fastener is a pin.

3. The fishing rod assembly as set forth in claim 1, in which said foot of the reel includes a fastening plate arranged in a longitudinal direction of the rod with at least one recess.

4. The fishing rod assembly as set forth in claim 1 in which an angular position (α) of a longitudinal centerline (A) of the reel and reel thereof is variable relative to a longitudinal direction (A′) of the rod, said two longitudinal centerlines (A, A′) being oriented in the same plane, the at least one fastener means serving to position the wanted angular position.

5. The fishing rod assembly as set forth in claim 1, in which said foot of the reel is hinged to pivot about a shaft arranged at the rod and oriented parallel to a longitudinal direction of one of the foot (and rod) to allow the reel to pivot relative to the rod.

6. The fishing rod assembly as set forth in claim 1, in which said foot of the reel comprises multiple recesses arranged one above the other.

7. The fishing rod assembly as set forth in claim 1, in which said foot of the reel comprises tooth and/or shaft drillings.

8. The fishing rod assembly as set forth in claim 1, in which said rod comprises a third recess channeling parts of the foot arranged offset by 90° from the recess for receiving the detachable fastener.

9. The fishing rod assembly as set forth in claim 1, in which said first recess is formed in a thickened portion of the rod.

10. The fishing rod assembly as set forth in claim 1, in which said second recess is formed in a fastening plate of the foot.

11. The fishing rod assembly as set forth in claim 10, in which said fastening plate comprises multiple recesses arranged one above the other.

12. The fishing rod assembly as set forth in claims 10, in which said fastening plate comprises tooth and/or shaft drillings.

13. The fishing rod assembly as set forth in claim 8, in which said third recess channeling parts of the foot is a full-length recess offset by 90° from the first recess for receiving the detachable fastener.

14. The fishing rod assembly as set forth in claim 1, in which the at least one detachable fastener is selected from a group consisting of a spring pin, pressure pin and gib.
